(19) United States
(12) Patent Application Publication
(10) Pub. No.: US 2016/0011812 A1
(43) Pub. Date: Jan. 14, 2016

(54) Memory System

(71) Applicant: Kabushiki Kaisha Toshiba, Tokyo (JP)

(72) Inventor: Takehiko Amaki, Yokohama Kanagawa (JP)

(21) Appl. No.: 14/481,622

(22) Filed: Sep. 9, 2014

Related U.S. Application Data
(60) Provisional application No. 62/022,321, filed on Jul. 9, 2014.

(51) Int. Cl. G06F 3/06; G06F 12/08

(52) U.S. Cl. CPC G06F 3/0625; G06F 12/0866; G06F 3/0634; G06F 3/0656; G06F 3/0679; G06F 2212/1028; G06F 2212/2022; G06F 2212/214; G06F 2212/222; G06F 2212/281; G06F 2212/313

(57) ABSTRACT

According to one embodiment, a memory system includes a memory and a controller. The controller includes a data transfer unit and a speed control unit. The speed control unit controls a transfer speed of the data transfer unit based on a state of a data transfer destination during an operation of the memory.

### CROSS-REFERENCE TO RELATED APPLICATIONS

This application claims the benefit of U.S. Provisional Application No. 62/022,321, filed Jul. 9, 2014, the entire contents of which are incorporated herein by reference.

### FIELD

Embodiments described herein relate generally to a memory system.

### BACKGROUND

There is a solid-state drive (SSD) comprising a semiconductor memory as a storage medium and having the same interface as a hard disk drive (HDD). Power consumption tends to increase as the performance of this solid-state drive improves.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram illustrating a memory system of a first embodiment;

FIG. 2 is an equivalent circuit diagram illustrating physical blocks constituting a NAND flash memory in FIG. 1;

FIG. 3 is a block diagram illustrating a speed control unit of the first embodiment;

FIG. 4 is a flowchart illustrating an operation of the speed control unit of the first embodiment;

FIG. 5 is a graph illustrating a transition example of a speed value of a read data path of the first embodiment;

FIG. 6 is a block diagram illustrating a speed control unit of a second embodiment;

FIG. 7 is a flowchart illustrating an operation of the speed control unit of the second embodiment;

FIG. 8 is a graph illustrating a transition example of a speed value of a write data path of the second embodiment;

FIG. 9 is a block diagram illustrating a speed control unit of a third embodiment;

FIG. 10 is a flowchart illustrating an operation of the speed control unit of the third embodiment;

FIG. 11 is a graph illustrating a transition example of a speed value of a write buffer of the third embodiment; and

FIG. 12 is a graph illustrating a transition example of a speed value of a compaction buffer of the third embodiment.

### DETAILED DESCRIPTION

Various embodiments will be described hereinafter with reference to the accompanying drawings.

In general, according to one embodiment, a memory system comprises a memory and a controller. The controller comprises a data transfer unit and a speed control unit. The speed control unit controls a transfer speed of the data transfer unit based on a state of a data transfer destination during an operation of the memory.

In this specification, some components are expressed by two or more terms. These terms are merely examples and the above-mentioned components may be expressed by another or other terms. The other components, which are not expressed by two or more terms, may be expressed by another or other terms.

### First Embodiment

### Example of Reducing Consumption Power During Data Read

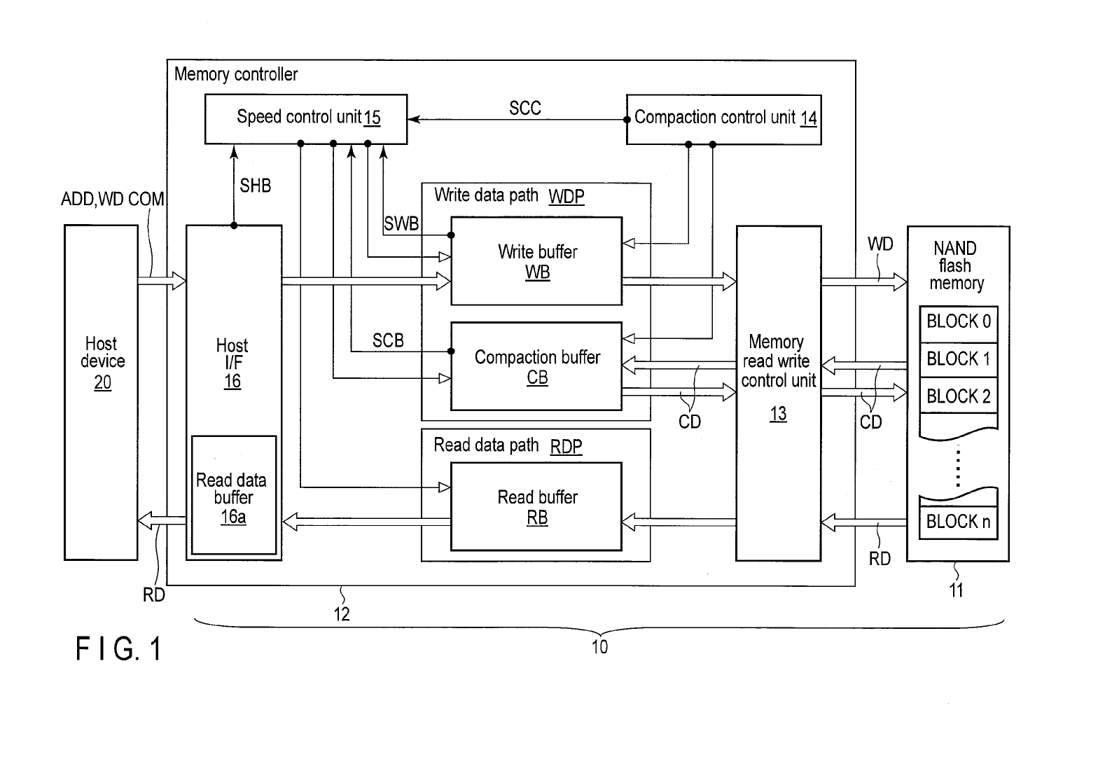

A solid-state drive 10 of the first embodiment will be described with reference to FIGS. 1 to 5. The first embodiment relates to reducing power consumption of the solid-state drive 10 during a data read operation.

[1. Whole Structure (Solid-State Drive)]

First of all, the whole structure of the solid-state drive 10 of the first embodiment will be described with reference to FIG. 1. The solid-state drive 10 is an example of a “memory system,” a “semiconductor device” and a “semiconductor storage device,” respectively. The solid-state drive 10 is used by being connected to, for example, a host device 20. The solid-state drive 10 receives from the host device 20 a data read request, a data write request and a data delete request. For example, the host device 20 may be an electronic device such as a server or an electronic device such as a portable computer and a tablet device.

As shown in the figure, the solid-state drive 10 of the first embodiment comprises a NAND flash memory 11 and a memory controller 12. The solid-state drive 10 receives a request (for example, data read request) from the host device 20 and performs an operation (for example, data read) of the request for the NAND flash memory 11.

The NAND flash memory (referred to as the NAND memory hereinafter) 11 is an example of a “memory” and a “storage unit,” respectively. Note that a memory or a storage unit to which the present embodiment is applicable is not limited to a NAND memory. The NAND memory 11 comprises, for example, a plurality of physical blocks (BLOCK 0, BLOCK 1, BLOCK 2, . . . , BLOCK n). In the NAND memory 11, data is deleted collectively in a unit of this physical block. That is, this physical block is a data delete unit. Note that the detail of the NAND memory 11 will be described in detail later.

The memory controller 12 is an example of a “controller” and a “control unit,” respectively. The memory controller 12 controls the whole operation of the NAND memory 11 in accordance with an instruction (demand or command) from the host device 20. The memory controller 12 performs access control for the NAND memory 11. The memory controller 12 of the present embodiment comprises a read data path RDP, a write data path WDP, a memory read write control unit 13, a compaction control unit 14, a speed control unit 15 and a host I/F (host interface) 16.

The read data path (read data transfer unit) RDP includes a read buffer RB. The clock region, power region and well of the read buffer RB are electrically separated from those of the other regions. The clock region, power region and well of the read buffer RB are electrically separated from, for example, those of a write buffer WB and a compaction buffer CB. Therefore, the read buffer RB is capable of controlling a data transfer speed (processing speed) independently from, for example, the write buffer WB and the compaction buffer CB, by controlling at least any one of a clock frequency, a power voltage and a substrate bias.

The write data path (write data transfer unit) WDP comprises the write buffer WB and the compaction buffer CB. The Clock regions, power regions and wells of the write buffer WB and the compaction buffer CB are electrically separated from those of the other regions. Also, the clock regions, power regions and wells of the write buffer WB and the compaction buffer CB are electrically separated from each other, for example. Therefore, each of the write buffer WB and the compaction buffer CB is capable of controlling a data transfer speed (processing speed), for example, independently from the read buffer RB and independently from each other by controlling at least any one of a frequency, a power voltage and a substrate bias.

Here, each of the read buffer RB, the write buffer WB and the compaction buffer CB is an example of a “buffer” and a “data transfer unit,” respectively. The read buffer RB, the write buffer WB and the compaction buffer CB are constituted by, for example, a static random access memory (SRAM).

The memory read write control unit (memory interface) 13 is an example of an “interface unit” and a “communication unit,” respectively. The memory read write control unit 13 is positioned between the read data path RDP and the write data path WDP and the NAND memory 11 and performs interface processing between the memory controller 12 and the NAND memory 11.

The memory read write control unit 13 controls data read, data write, etc., for the NAND memory 11. For example, the memory read write control unit 13 reads out predetermined read data RD from the NAND memory 11 and transfers it to the read data path RDP. The memory read write control unit 13 also writes predetermined write data WD, which is transferred from the write data path WDP, to the NAND memory 11. That is, the memory read write control unit 13 transmits the write data that the write data path WDP transfers to the memory read write control unit 13, to the NAND memory 11 which is the outside of the memory controller 12.

The compaction control unit 14 controls the write data amount from the compaction buffer CB (referred to as a compaction ratio hereinafter) to the amount of data that the write buffer WB writes to the NAND memory 11 via the memory read write control unit 13.

The speed control unit 15 receives from the host I/F 16 the types of commands being executed and congestion information SHB of a read data buffer 16a in the host I/F 16 during the data read operation from the NAND memory 11. The congestion information SHB may include at least any one of the fact that the read data buffer 16a in the host I/F 16 cannot store data any more (so-called full state), the fact that the data storage state of the read data buffer 16a exceeds a predetermined percentage and the fact that the read data buffer 16a is expected to, for example, be in the full state within a predetermined time.

The speed control unit 15 controls the speed of the read data path RDP (for example, the transfer speed of the read buffer RB) based on the congestion information SHB, which is received from the host I/F 16. Note that the above-mentioned congestion information SHB can be a signal (control signal) that the host I/F 16 transmits in accordance with the congestion situation of the read data buffer 16a. That is, the speed control unit 15 may control the speed of the read data path RDP based on a signal transmitted from the host I/F 16.

Also, the speed control unit 15 may receive predetermined information (for example, the congestion information of the read buffer RB) from the read buffer RB and control the speed of the read data path RDP based on the information, instead of or in addition to the above-mentioned example. The congestion information of the read buffer RB may include at least any one of the fact that the read buffer RB cannot store data any more (so-called full state), the fact that the data storage state of the read buffer RB exceeds a predetermined percentage and the fact that the read buffer RB is expected to, for example, be in the full state within a predetermined time.

Further, the speed control unit 15 receives congestion information SWB of the write buffer WB from the write buffer WB during the operation of data write to the NAND memory 11. The congestion information SWB of the write buffer WB may include at least any one of the fact that the write buffer WB cannot store data any more (so-called full state), the fact that the data storage state of the write data buffer WB exceeds a predetermined percentage and the fact that the write buffer WB is expected to, for example, be in the full state within a predetermined time.

The speed control unit 15 controls the speed of the write data path WDP (for example, the transfer speed of the write buffer WB) based on the congestion information SWB, which is received from the write buffer WB. Note that the above-mentioned congestion information SWB can be a signal (control signal) that the write buffer WB transmits in accordance with its congestion situation. That is, the speed control unit 15 controls the speed of the write data path WDP based on a signal transmitted from the write buffer WB.

In addition, the speed control unit 15, during the data write operation, receives congestion information SCB of the compaction buffer CB from the compaction buffer CB and receives from the compaction control unit 14 information SCC including a compaction ratio and a fact which indicates whether compaction processing is being performed or not.

The speed control unit 15 controls the speed of the write data path WDP (for example, the transfer speed of the compaction buffer CB) based on the congestion information SCB received from the compaction buffer CB and the information SCC received from the compaction control unit 14. Note that the above-mentioned congestion information SCB can be a signal (control signal) that the compaction buffer CB transmits in accordance with its congestion situation. That is, the speed control unit 15 may control the speed of the write data path WDP based on a signal transmitted from the compaction buffer CB.

Also, the speed control unit 15 may receive predetermined information from the memory read write control unit 13 (for example, congestion information of the write data buffer in the memory read write control unit 13) and control the speed of the write data path WDP based on the information, instead of or in addition to the above-mentioned example.

Specifically, the speed control unit 15 performs speed control of the read buffer RB, the write buffer WB and the compaction buffer CB by controlling at least any one of a frequency, a power voltage and a substrate bias for each of the read buffer RB, the write buffer WB and the compaction buffer CB. The detail of the speed control unit 15 will be described later.

The host I/F 16 is an example of an “interface unit” and a “communication unit,” respectively. The host I/F 16 is positioned between the read data path RDP and the write data path WDP and the host device 20 and performs interface processing between the memory controller 12 and the host device 20.

The host I/F 16 receives the predetermined write data WD from the host device 20 and transfers it to the write data path WDP. Also, the host I/F 16 has the read data buffer 16a that temporarily stores the read data RD, which is transmitted from the read buffer RB, and performs communication between the host device 20 and the memory controller 12. The host I/F 16 transmits to the host device 20 the predetermined read data RD, which is transferred from the read data path RDP. That is, the host I/F 16 transmits to the outside of the memory controller 12 the data that the read data path RDP transfers to the host I/F 16. Note in the present embodiment that the maximum processing speed of the read data path RDP (the maximum processing speed of the read buffer RB) is higher than the maximum processing speed of the host I/F 16.

[1-1. NAND Memory]

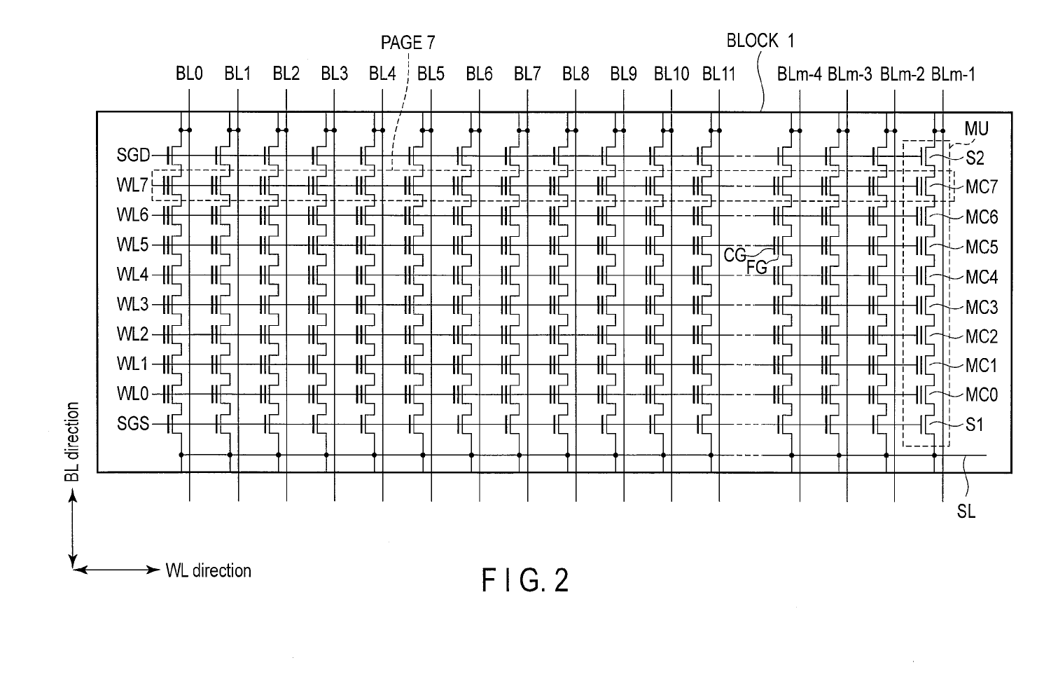

Next, the physical blocks constituting the NAND memory 11 in FIG. 1 will be described with reference to FIG. 2. Here, a single physical block (BLOCK 1) in FIG. 1 will be described as an example.

The physical block (BLOCK 1) comprises a plurality of memory cell units MUs, which are arranged in a word line direction (WL direction). The memory cell unit MU is arranged in a bit line direction (BL direction) crossing the word line direction and comprises a NAND string (memory cell string) consisting of eight memory cells MC0 to MC7 where a current pathway is connected in serial, a source-side select transistor S1 connected to an end of the current pathway of the NAND string, and a drain-side select transistor S2 connected to the other end of the current pathway of the NAND string. Each of the memory cells MC0 to MC7 comprise a control gate CG and a floating gate FG. Note that the memory cell unit MU here comprises the eight memory cells MC0 to MC7, but is not limited thereto. The memory cell unit MU should comprise two or more (for example, 56 or 32) memory cells.

The other end of the current pathway of the source-side select transistor S1 is commonly connected to a source line SL. The other end of the current pathway of the drain-side select transistor S2 is connected to one of bit lines BL0 to BLm-1.

Word lines WL0 to WL7 are commonly connected to the control gate CG of each of the plurality of memory cells MC0 to MC7 in the word line direction. A select gate line SGS is commonly connected to gate electrodes of a plurality of select transistors S1 in the word line direction. A select gate line SGD is also commonly connected to gate electrodes of a plurality of select transistors S2 in the word line direction.

Also, a page (PAGE) exists in each of the word lines WL0 to WL7. For example, as shown in the broken line in the figure, PAGE 7 exists in the word line WL7. For each PAGE, a data read operation and a data write operation are performed. Therefore, PAGE is a data read unit and a data write unit.

[1-2. Speed Control Unit]

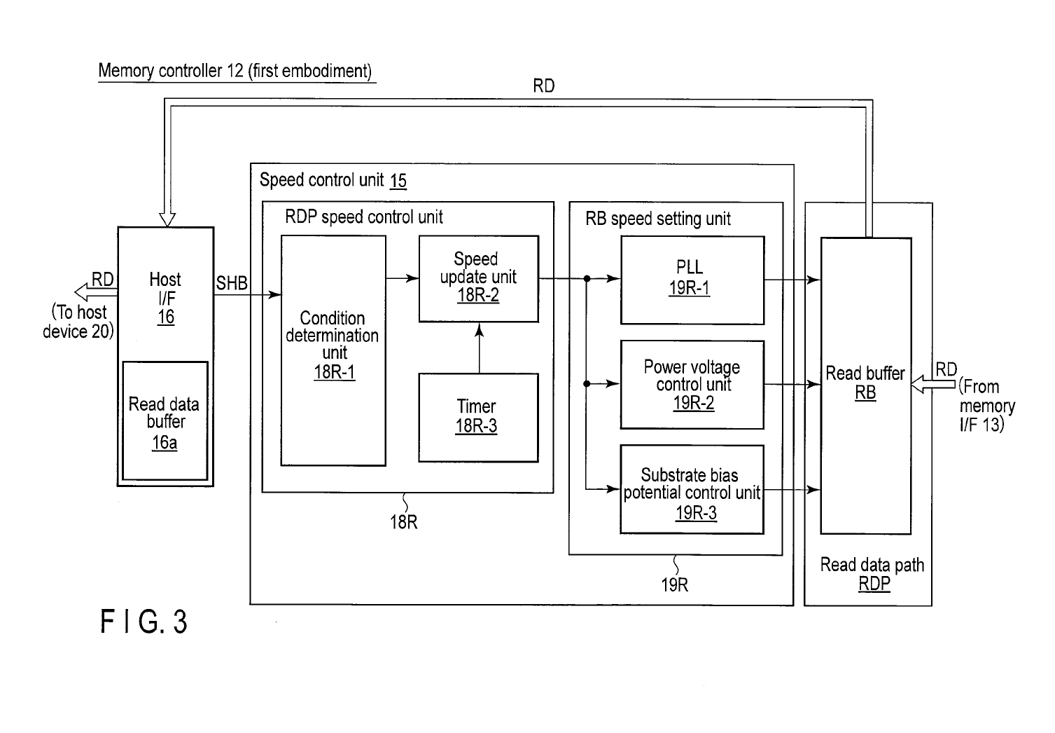

Next, the speed control unit 15 of the first embodiment will be described in more detail with reference to FIG. 3. As shown in the figure, the speed control unit 15 of the first embodiment, during the data read operation of the NAND memory 11, receives the congestion information SHB of the read data buffer 16a transmitted from the host I/F 16 and controls the speed of the read data path RDP based on the received congestion information SHB. Therefore, the read data RD read from the NAND memory 11 and stored in the read buffer RB is transferred to the read data buffer 16a in the host I/F 16 at a controlled speed.

Specifically, the speed control unit 15 of the first embodiment comprises a RDP speed control unit 18R and a RB speed setting unit 19R.

The RDP speed control unit 18R comprises a condition determination unit 18R-1, a speed update unit 18R-2 and a timer 18R-3. The condition determination unit 18R-1 performs the condition judgment of a speed update based on the congestion information SHB, which is received from the host I/F 16. The speed update unit 18R-2 updates a speed value at a timing notified from the timer 18R-3 based on a determination result output from the condition determination unit 18R-1. The timer 18R-3 notifies the speed update unit 18R-2 of the timing of a speed update.

The RB speed setting unit 19R receives a speed value updated at the RDP speed control unit 18R and sets the speed of the read buffer RB so as to reach the updated and received speed value. The RB speed setting unit 19R comprises a clock frequency control unit (PLL) 19R-1, a power voltage control unit 19R-2 and a substrate bias potential control unit 19R-3.

The frequency control unit 19R-1 sets the frequency of the read buffer RB so as to reach the updated speed value. The power voltage control unit 19R-2 sets the power voltage of the read buffer RB so as to reach the updated speed value. The substrate bias potential control unit 19R-3 sets the substrate bias of the read buffer RB so as to reach the updated speed value. More specifically, the power voltage control unit 19R-2 and the substrate bias potential control unit 19R-3 are provided by, for example, a voltage conversion circuit. The RB speed setting unit 19R performs speed control, for example, by adjusting the clock frequency of the read buffer RB and by adjusting the power voltage and the substrate bias potential according to the clock frequency.

Note that the RB speed setting unit 19R may change the speed of the read buffer RB by controlling at least any one of the clock frequency control unit 19R-1, the power voltage control unit 19R-2 and the substrate bias potential control unit 19R-3.

[2-1. Speed Control Operation in Data Read]

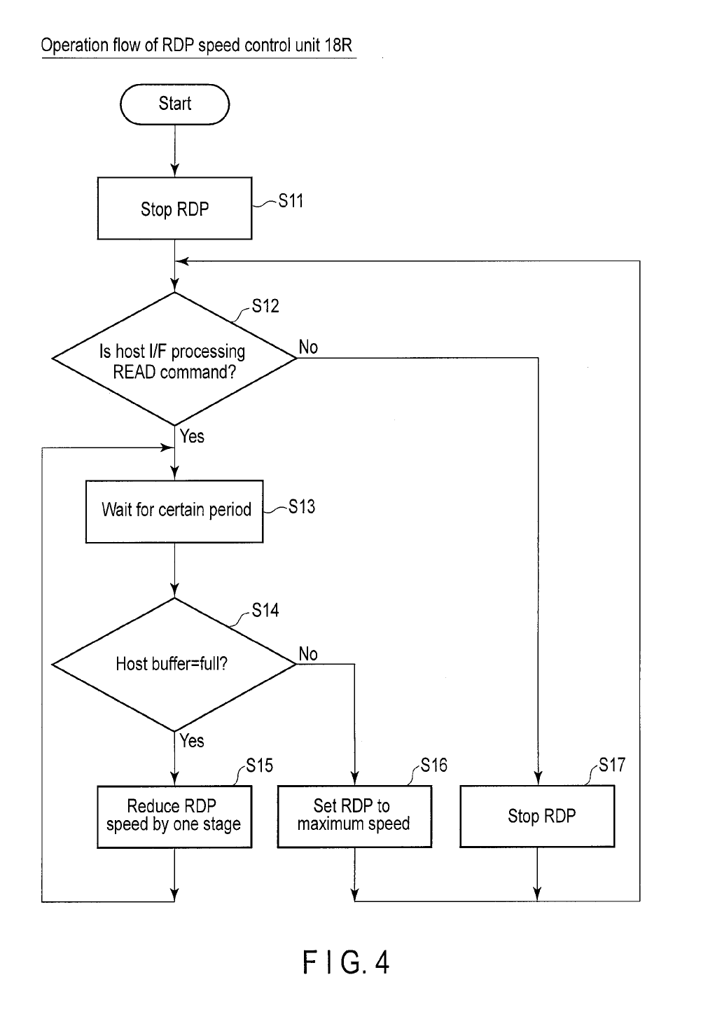

Regarding the above-mentioned structure, the operation of the RDP speed control unit 18R of the first embodiment will be described with reference to FIG. 4. FIG. 4 is a flowchart illustrating the operation of the RDP speed control unit 18R of the first embodiment. Here, the RDP speed control unit 18R changes the speed value of the read data path RDP in stage m, from 0 to m−1. Also, speed value 0 represents a stopped state of the read data path RDP. Speed value m−1 is an example of the “first transfer speed.” Speed value m−2 is an example of the “second transfer speed.” That is, the data transfer speed of the read data path RDP can be changed at least to the first transfer speed and the second transfer speed, which is lower than the first transfer speed, in addition to the stopped state.

First of all, the RDP speed control unit 18R stops the read data path RDP in step S11, as shown in the figure. That is, the RDP speed control unit 18R makes the speed value of the read data path RDP 0.

In step S12, the RDP speed control unit 18R determines whether the host I/F 16 is processing a READ command.

In step S13, the RDP speed control unit 18R waits only for a predetermined certain time (t_{RDP}), when processing a READ command in the above-mentioned step S12 (Yes).

In step S14, the RDP speed control unit 18R refers to the congestion information SHB of the read data buffer 16a of the host I/F 16. Specifically, the RDP speed control unit 18R determines whether the data storage state of the read data buffer 16a of the host I/F 16 is a predetermined state (for example, full state [a state where data cannot be stored any more]) (host buffer=full). Note that the determination condition is not limited to a full state in step S14. For example, the determination condition should be an optional predetermined state such as a state where the data storage state of the read data buffer 16a is 90% or more, or a state expected to be a full state within a predetermined time by calculation such as linear compensation.

In step S15, the RDP speed control unit 18R reduces the speed of the read data path RDP by one stage, when in a predetermined state (for example, full state) in the above-mentioned step S14 (Yes).

In step S16, the RDP speed control unit 18R returns the speed of the read data path RDP to initial value m−1, which is the maximum value, when not in the predetermined state (for example, full state) in the above-mentioned step S14 (No).

In step S17, the RDP speed control unit 18R sets the speed value of the read data path RDP to 0 to stop the read data path RDP, when not processing a READ command in the above-mentioned step S12 (No). By controlling in such a manner, it is possible to reduce consumption power during a data read operation, when the frequency of a read request is low.

The RDP speed control unit 18R repeats the above-mentioned operations in the data read operation of the NAND memory 11.

[2-2. Transition Example of Speed Value of Read Data Path RDP]

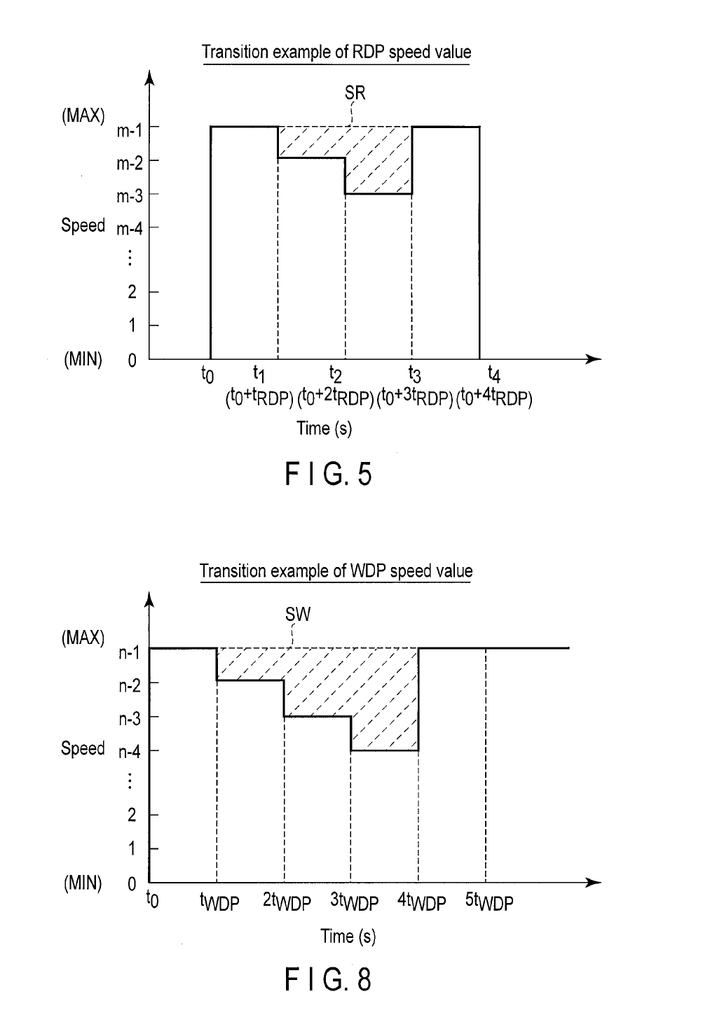

As a result of the above-mentioned speed control, the speed value of the read data path RDP is as shown in, for example, FIG. 5. FIG. 5 is a graph illustrating a transition example of the speed value of the read data path RDP in accordance with the operation flow of FIG. 4.

As shown in the figure, the RDP speed control unit 18R sets the speed of the read data path RDP to maximum value m−1, which is an initial value, at time t0 when the processing of a READ command is started and the data read operation of the NAND memory 11 is started.

Next, the RDP speed control unit 18R reduces the speed by one stage, respectively (m−2 and m−3), at times t1 (t0+t_{RDP}) to t2 (t0+2t_{RDP}) when predetermined time t_{RDP} passes, if the data storage state of the read data buffer 16a of the host I/F 16 is a predetermined state (for example, full state).

Subsequently, the RDP speed control unit 18R returns the speed of the read data path RDP to maximum value m−1 at time t3 (t0+3t_{RDP}), if the data storage state of the read data buffer 16a is not in the predetermined state (for example, full state).

Then, the RDP speed control unit 18R stops the operation of the read data path RDP after completing READ command processing.

[3. Effect]

As described above, at least the following effects (1) and (2) can be obtained by the structure and the operation of the solid-state drive 10 of the first embodiment.

(1) It is possible to reduce consumption power during a data read operation.

Here, the power consumption of a memory controller tends to increase as the performance of a solid-state drive improves. For example, among consumption power, the consumption power in the RAM section of a read buffer, a write buffer and a compaction buffer, etc., accounts for a relatively large proportion. Therefore, it is desired that such consumption power be reduced. However, no consideration is given to reducing the consumption power of the above-mentioned RAM section during an operation where a memory controller processes a request such as data read. Accordingly, there is a case where consumption power is not reduced sufficiently.

On the other hand, the memory controller 12 of the first embodiment comprises the speed control unit 15 that controls a transfer speed of the read data path RDP based on the congestion information SHB from the host I/F 16 during the data read operation of the NAND memory 11. In other words, the memory controller 12 comprises the speed control unit 15 that controls the transfer speed of the read buffer RB so as to reduce the transfer speed of the read buffer RB, by reducing at least the power voltage of the read buffer RB when the data transfer speed of the read buffer RB is higher than the data transmission speed of the host I/F (interface unit) 16.

For example, the RDP speed control unit 18R of the speed control unit 15 reduces the speed of the read data path RDP by one stage when the data storage state of the read data buffer 16a of the host I/F 16 is a full state during the data read operation of the NAND memory 11 (S15, times t1 to t3).

As shown in FIG. 5, it is therefore possible to reduce dynamic consumption power corresponding to an area SR, which is encircled by a broken line, during a data read operation. That is, the speed of the read data path RDP, which is not the bottleneck of processing, is reduced by detecting the state of the host I/F (interface unit) 16, which is the bottleneck of processing, based on the congestion information SHB. As a result, it is possible to reduce consumption power effectively during data read by cutting the peak (area SR) of an extra speed value, for example, without substantially reducing the processing speed as a whole of the solid-state drive 10.

In addition, the read buffer RB of the first embodiment is capable of controlling a data transfer speed by controlling at least any one of a clock frequency, a power voltage and a substrate bias. The reduction effect of consumption power is thus huge since the read buffer RB reduces speed by directly reducing a power voltage as well as a clock frequency, etc. Also, it is possible to reduce consumption power by reducing a leak current in the read buffer RB by reducing the power voltage.

(2) The temporal overhead accompanied with speed switching is small.

Here, it is assumed for comparison that consumption power is reduced by frequently stopping the clock and power of the read data path during processing such as a data read request. However, there is a possibility that the reduction effect of consumption power is limited if only the clock is stopped and the power voltage is kept. There is also a possibility that a temporal overhead necessary for stopping and returning power is large if the supply of power voltage is stopped frequently.

On the other hand, as shown in FIG. 5, the data transfer speed of the read path data RDP is set in a plurality of stages 0 to m−1 in the present embodiment. The RDP speed control unit 18R reduces the data transfer speed of the read data path RDP by one stage (times t1 to t2) from maximum value m−1 and returns to the initial value, i.e., maximum value m−1 of the data transfer speed of the read data path RDP, when not in a predetermined state (for example, full state) (time t3).

Thus, the RDP speed control unit 18R does not completely stop supplying power voltage to the read buffer RB even in a predetermined state (for example, full state) and operates the read buffer RB at a gradually reduced speed. When not in the predetermined state (for example, full state), the value is returned to the initial value, i.e., maximum value m−1. Therefore, there is an advantage that a temporal overhead accompanied with speed switching is small. Also, by controlling in such a manner, it is possible to reduce consumption power in operation without deteriorating the whole data read speed.

### Second Embodiment

### Example of Consumption Power Reduction in Data Write

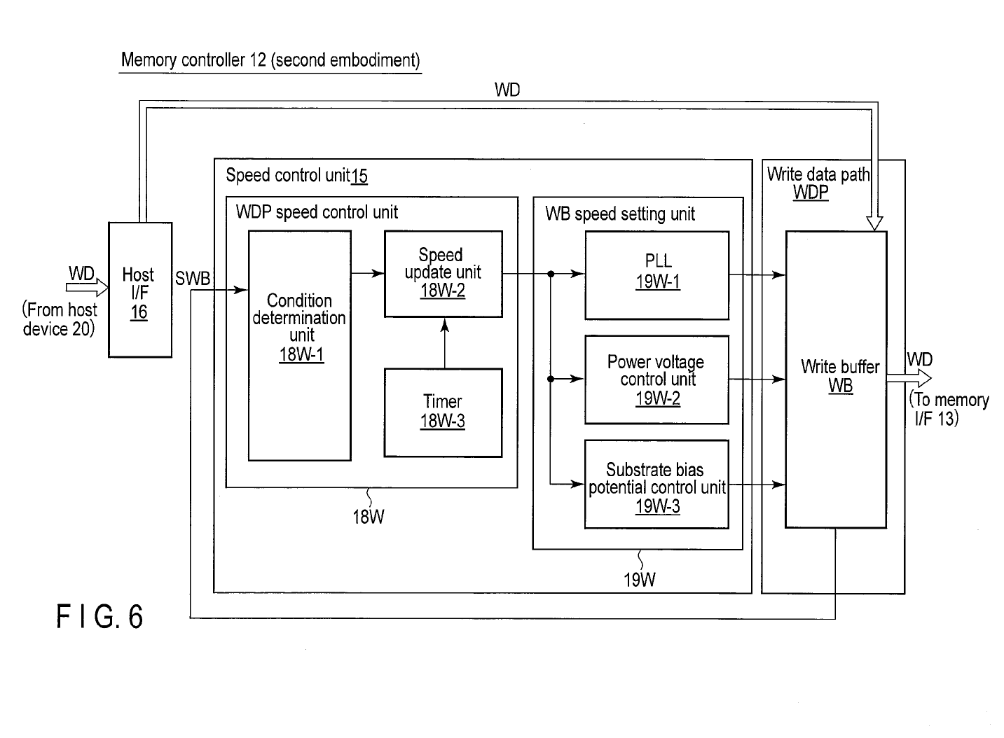

Next, the solid-state drive 10 of the second embodiment will be described with reference to FIGS. 6 to 8. The second embodiment relates to reducing power consumption of the solid-state drive 10 during a data write operation. In this explanation, a detailed explanation overlapping with the above-mentioned first embodiment will be omitted. Note that the structure other than described below is the same as the above-mentioned first embodiment.

[Speed Control Unit]

First of all, the speed control unit 15 of the second embodiment will be described with reference to FIG. 6. As shown in the figure, the speed control unit 15 of the second embodiment further comprises a WDP speed control unit 18W and a WB speed control setting unit 19W, which differs from the first embodiment.

In the above-mentioned structure, the speed control unit 15, during the data write operation of the NAND memory 11, receives the congestion information SWB of the write buffer WB and controls the speed of the write data path WDP (for example, the transfer speed of the write buffer WB) based on the received congestion information SWB. Therefore, the write data WD stored in the write buffer WB to be written to the NAND memory 11 is transferred from the write buffer WB to the memory read write control unit 13 at a controlled speed.

The WDP speed control unit 18W comprises a condition determination unit 18W-1, a speed update unit 18W-2 and a timer 18W-3. The condition determination unit 18W-1 performs the condition judgment of a speed update based on the congestion information SWB, which is received from the write buffer WB. The speed update unit 18W-2 updates a speed value at a timing notified from the timer 18W-3 based on a determination result output from the condition determination unit 18W-1. The timer 18W-3 notifies the speed update unit 18W-2 of the timing of a speed update.

The WB speed setting unit 19W receives a speed value updated at the WDP speed control unit 18W and sets the speed of the write buffer WB so as to reach the updated and received speed value. As with the RB speed control unit 18 of the first embodiment, the WB speed setting unit 19W comprises a clock frequency control unit (PLL) 19W-1, a power voltage control unit 19W-2 and a substrate bias potential control unit 19W-3. The WB speed setting unit 19W performs speed control, for example, by adjusting the clock frequency of the write buffer WB and by adjusting the power voltage and the substrate bias potential according to the clock frequency.

Note that the WB speed setting unit 19W may change the speed of the write buffer WB by controlling at least any one of the clock frequency control unit 19W-1, the power voltage control unit 19W-2 and the substrate bias potential control unit 19W-3.

[Speed Control Operation in Data Write]

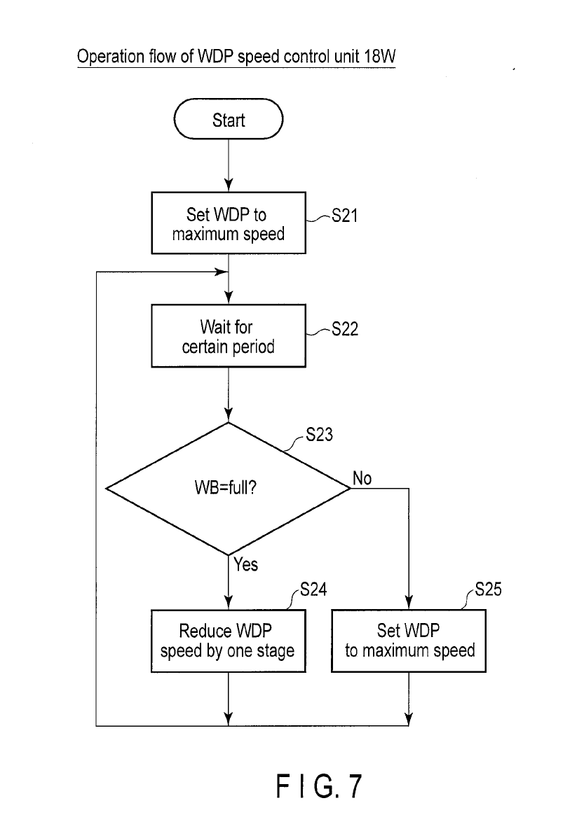

Regarding the above-mentioned structure, the operation of the WDP speed control unit 18W of the second embodiment will be described with reference to FIG. 7. FIG. 7 is a flowchart illustrating the operation of the WDP speed control unit 18W of the second embodiment. Here, the WDP speed control unit 18W changes the speed value of the write data path WDP in stage n, from 0 to n−1, as with the RB speed control unit 18 of the first embodiment. Also, speed value 0 represents a stopped state of the write data path WDP. Speed value n−1 is an example of a “first transfer speed.” Speed value n−2 is an example of a “second transfer speed.” That is, the data transfer speed of the write data path WRD can be changed at least to the first transfer speed and the second transfer speed, which is smaller than the first transfer speed, in addition to the stopped state.

First of all, as shown in the figure, the WDP speed control unit 18W sets the speed of the write data path WDP to maximum n−1 in step S21.

In step S22, the WDP speed control unit 18W waits only for a predetermined certain time (t_{WDP}).

In step S23, the WDP speed control unit 18W refers to the congestion information SWB of the write buffer WB to determine whether the data storage state of the write buffer WB is in a predetermined state (for example, full state [a state where data cannot be stored any more]) (WB=full). Note that the determination condition is not limited to the full state in step S23, as with the above.

In step S24, the WDP speed control unit 18W reduces the speed of the write data path WDP by one stage, when in a predetermined state (for example, full state) in the above-mentioned step S23 (Yes).

In step S25, the WDP speed control unit 18W returns the speed of the write data path WDP to initial value n−1, which is the maximum value, when not in the predetermined state (for example, full state) in the above-mentioned step S23 (No).

The WDP speed control unit 18W repeats the above-mentioned operations during the data write operation of the NAND memory 11.

[Transition Example of Speed Value of Write Data Path WDP]

As a result of the above-mentioned speed control, the speed value of the write data path is as shown in, for example, FIG. 8. FIG. 8 is a graph illustrating a transition example of the speed value of the write data path WDP in accordance with the operation flow of FIG. 7.

First of all, as shown in the figure, a data write operation starts at time t0 to start the processing of a WRITE command.

Next, the WDP speed control unit 18W reduces the speed of the write data path WDP from initial value n−1 to n−4 by one stage at times t_{WDP} to 3t_{WDP} since the write buffer WB is in a predetermined state (for example, full state [WB=full]).

Subsequently, the WDP speed control unit 18W returns to initial value n−1 at time 4t_{WDP} when the write buffer WB is not in the predetermined state (for example, full state).

The WDP speed control unit 18W repeats the above-mentioned operations.

[Effect]

As described above, at least the above-mentioned effects (1) and (2) can be obtained by the structure and the operation of the solid-state drive 10 of the second embodiment. Further, the following effect (3) can be obtained according to the second embodiment.

(3) It is possible to reduce consumption power during a data write operation.

The speed control unit 15 of the second embodiment further comprises the WDP speed control unit 18W and the WB speed control setting unit 19W. The WDP speed control unit 18W reduces the speed of the write data path WDP by one stage when the data storage state of the write buffer WB is a predetermined state (for example, full state) based on the congestion information SWB during the data write operation of the NAND memory 11 (S24, times t_{WDP} to 3t_{WDP}).

As shown in FIG. 8, it is therefore possible to reduce dynamic consumption power corresponding to an area SW, which is encircled by a broken line, during a data write operation. That is, the speed of the write data path WDP, which is not the bottleneck of processing, is reduced by detecting the state of the memory read write control unit (interface unit) 13, which is the bottleneck of processing, based on the congestion information SWB. As a result, it is possible to reduce consumption power effectively during data write by cutting the peak (area SW) of an extra speed value, for example, without substantially reducing the processing speed as a whole of the solid-state drive 10. Also, it is possible to reduce consumption power by reducing a leak current in the write buffer WB by reducing a power voltage.

### Third Embodiment

### Example of Consumption Power Reduction in Data Compaction

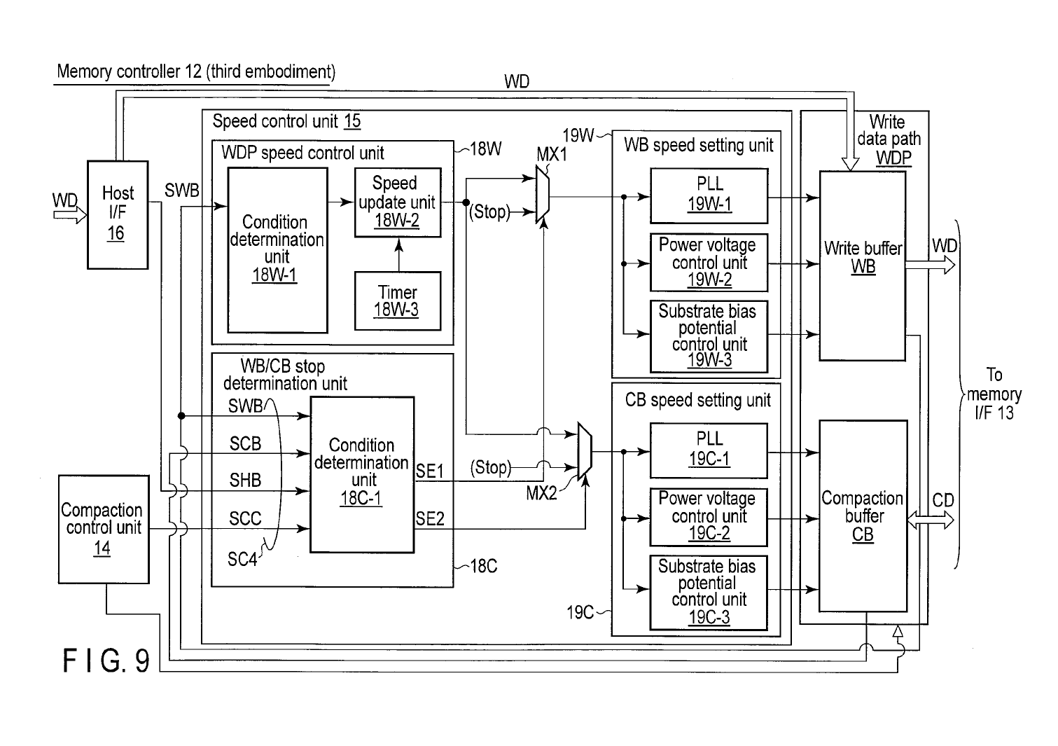

Next, the solid-state drive 10 of the third embodiment will be described with reference to FIGS. 9 to 12. The third embodiment relates to reducing power consumption of the solid-state drive 10 during a data compaction operation. In this explanation, a detailed explanation overlapping with the above-mentioned first and second embodiments will be omitted. Note that “data compaction” is synonymous with data garbage collection. The structure other than described below is the same as the above-mentioned second embodiment.

[Speed Control Unit]

First of all, the speed control unit 15 of the third embodiment will be described with reference to FIG. 9. As shown in the figure, the speed control unit 15 of the third embodiment further comprises a WB/CB speed control unit 18C (i.e., WB/CB stop determination unit), a CB speed setting unit 19C and select units MX1 and MX2, which differs from the above-mentioned embodiments.

In the above-mentioned structure of the present embodiment, the speed control unit 15, during the data write operation of the NAND memory 11, receives the congestion information SWB of the write buffer WB and controls the transfer speed of the write buffer WB and the transfer speed of the compaction buffer CB based on the received congestion information SWB. Therefore, the write data WD stored in the write buffer WB and compaction date CD stored in the compaction buffer CB which are to be written to the NAND memory 11 are transferred from the write buffer WB and the compaction buffer CB to the memory read write control unit 13 at a controlled speed.

Specifically, the WDP speed control unit 18W comprises the condition determination unit 18W-1, the speed update unit 18W-2 and the timer 18W-3, as with the second embodiment. The WB speed setting unit 19W and the CB speed setting unit 19C receive a speed value updated at the WDP speed control unit 18W and set the speed of the write buffer WB and the speed of the compaction buffer CB so as to reach the updated and received speed value. As with the RB speed setting unit 19R of the first embodiment, the CB speed setting unit 19C comprises a clock frequency control unit (PLL) 19C-1, a power voltage control unit 19C-2 and a substrate bias potential control unit 19C-3. The CB speed setting unit 19C performs speed control, for example, by adjusting the clock frequency of the compaction buffer CB and by adjusting the power voltage and the substrate bias potential according to the clock frequency.

Note that the CB speed setting unit 19C may change the speed of the compaction buffer CB by controlling at least any one of the clock frequency control unit 19C-1, the power voltage control unit 19C-2 and the substrate bias potential control unit 19C-3.

Also, in the above-mentioned structure, the speed control unit 15 stops the operation of either of the write buffer WB or the compaction buffer CB during the data write operation of the NAND memory 11, when a predetermined condition is satisfied. Note this stop operation will be described in detail later.

The WB/CB speed control unit 18C comprises a condition determination unit 18C-1. The condition determination unit 18C-1 outputs select signals SE1 and SE2 based on compaction information SC4, which includes the compaction control signal SCC and three pieces of information including the congestion information SHB, SWB and SCB.

The select unit MX1 selects either of an output of the WDP speed control unit 18W or a stop signal in accordance with the select signal SE1, and outputs it to the WB speed setting unit 19W. The select unit MX2 selects either of an output of the WDP speed control unit 18W or a stop signal in accordance with the select signal SE2, and outputs it to the CB speed setting unit 19C.

Upon receiving a speed value selected at the select unit MX2, which is updated at the WDP speed control unit 18W, the CB speed setting unit 19C sets the speed of the compaction buffer CB so as to reach the updated and received speed value. The compaction buffer CB performs read and write of compaction data CD for the NAND memory 11 to achieve a predetermined compaction ratio, in accordance with an updated speed. Also, the CB speed setting unit 19C stops the operation of the compaction buffer CB upon receiving a stop signal selected at the select unit MX2.

The compaction control unit 14 performs control of temporarily stopping data transmission from the write buffer WB or the compaction buffer CB to the memory I/F 13, in order to achieve a predetermined compaction ratio. Note in this case that the circuits themselves of the write buffer WB and the compaction buffer CB operate for performing a necessary operation such as read and rearrange for compaction.

Here, the compaction control unit 14 properly selects one of the three compaction ratios (1:1, 1:0 and 0:1) every time two-page data write is completed, in order to achieve an average compaction ratio, 1:N.

The compaction control unit 14 outputs a selected compaction ratio to the condition determination unit 18C-1 as the compaction control signal SCC. That is, the condition determination unit 18C-1 mainly performs the following three controls, I) to III), based on the congestion information SC4 including the compaction control signal SCC:

I) When the compaction ratio is 1:1, the write buffer WB and the compaction buffer CB perform data write by one page, respectively;

II) When the compaction ratio is 1:0, the write buffer WB performs data write for written data of two pages; and

III) When the compaction ratio is 0:1, the compaction buffer CB performs data write for written data of two pages.

The detail will be described in the following.

[Determination Operation in Data Compaction]

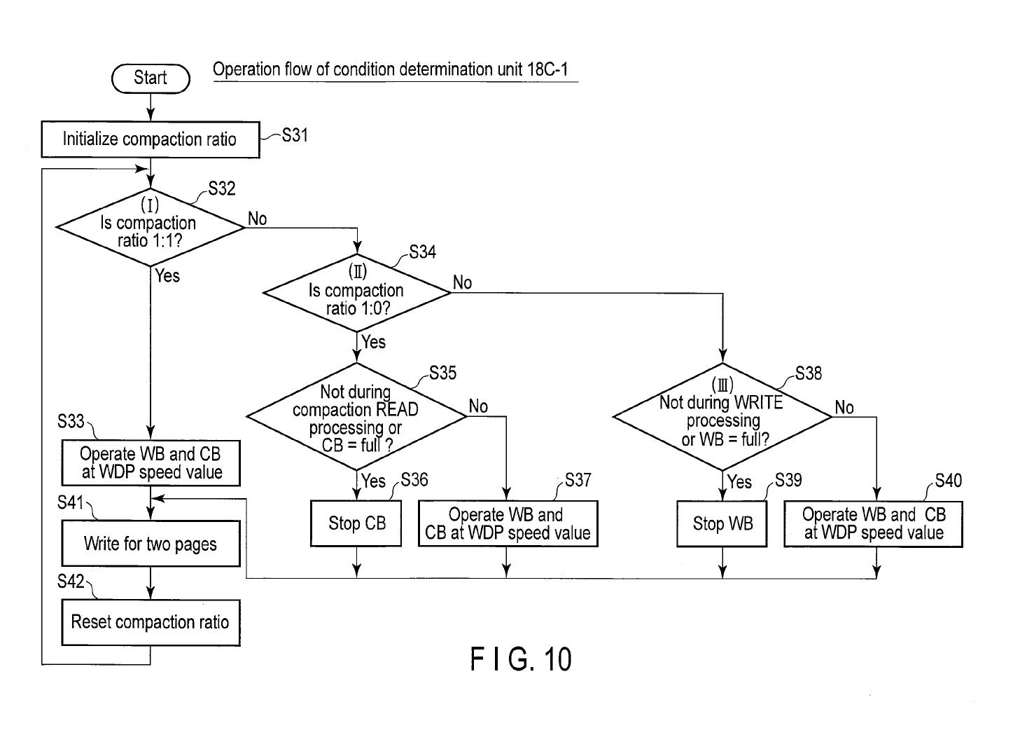

Next, regarding the above-mentioned structure, the determination operation of the condition determination unit 18C-1 of the third embodiment will be described with reference to FIG. 10. FIG. 10 is a flowchart illustrating the operation of the condition determination unit 18C-1 of the third embodiment.

First of all, as shown in the figure, the compaction control unit 14 initializes the compaction ratio in step S31.

In step S32, the condition determination unit 18C-1 determines whether the compaction ratio is 1:1.

In step S33, the condition determination unit 18C-1 outputs the select signals SE1 and SE2 so that the write buffer WB and the compaction buffer CB operate at an updated speed at the WDP speed control unit 18W, when the compaction ratio (1:1) is satisfied in the above-mentioned step S32 (Yes). That is, the condition determination unit 18C-1 does not output a stop signal in this case.

In step S34, the condition determination unit 18C-1 determines whether the compaction ratio is 1:0, when the compaction ratio (1:1) is not satisfied in the above-mentioned step S32 (No).

In step S35, the condition determination unit 18C-1 determines whether compaction READ processing is not being performed and whether the compaction buffer CB is in a full state (CB=full), when the compaction ratio (1:0) is satisfied in the above-mentioned step S34 (Yes).

In step S36, the condition determination unit 18C-1 stops the compaction buffer CB by controlling at least any one of the clock frequency, power voltage, and substrate bias potential of the compaction buffer CB, when the condition of the above-mentioned step S35 is satisfied (Yes) (that is, when compaction READ processing is not being performed or the compaction buffer CB is in a full state). That is, the operation of the compaction buffer CB is stopped (the operation of the circuit is stopped), when the processing to be performed by the compaction buffer CB does not exist or cannot be performed. On the other hand, the write buffer WB operates at a speed value updated at the WDP speed control unit 18W at this time.

In step S37, the condition determination unit 18C-1 controls the write buffer WB and the compaction buffer CB so that they perform at a speed value updated at the WDP speed control unit 18W, when the condition of the above-mentioned step S35 is not satisfied (No) (that is, when compaction READ processing is being performed and the compaction buffer CB is not in a full state).

In step S38, the condition determination unit 18C-1 determines whether a WRITE command is not being processed and whether the write buffer WB is in a full state (WB=full).

In step S39, the condition determination unit 18C-1 stops the write buffer WB by controlling at least any one of the clock frequency, power voltage, and substrate bias potential of the write buffer WB, when the condition of the above-mentioned step S38 is satisfied (Yes) (that is, when a WRITE command is not being processed or the write buffer WB is in a full state). That is, the operation of the write buffer WB is stopped (the operation of the circuit is stopped), when the processing to be performed by the write buffer WB does not exist or cannot be performed. On the other hand, at this time, the compaction buffer CB operates at a speed value updated at the WDP speed control unit 18W at this time.

In step S40, the condition determination unit 18C-1 controls the write buffer WB and the compaction buffer CB so that they perform at a speed value updated at the WDP speed control unit 18W, when the condition of the above-mentioned step S38 is not satisfied (No) (that is, when a WRITE command is being processed and the write buffer WB is not in a full state).

In step S41, the condition determination unit 18C-1 performs data write of two pages in each of the above-mentioned steps S33, S37 and S40.

In step S42, the compaction control unit 14 resets the compaction ratio.

[Transition Example of Speed Value in Data Compaction]

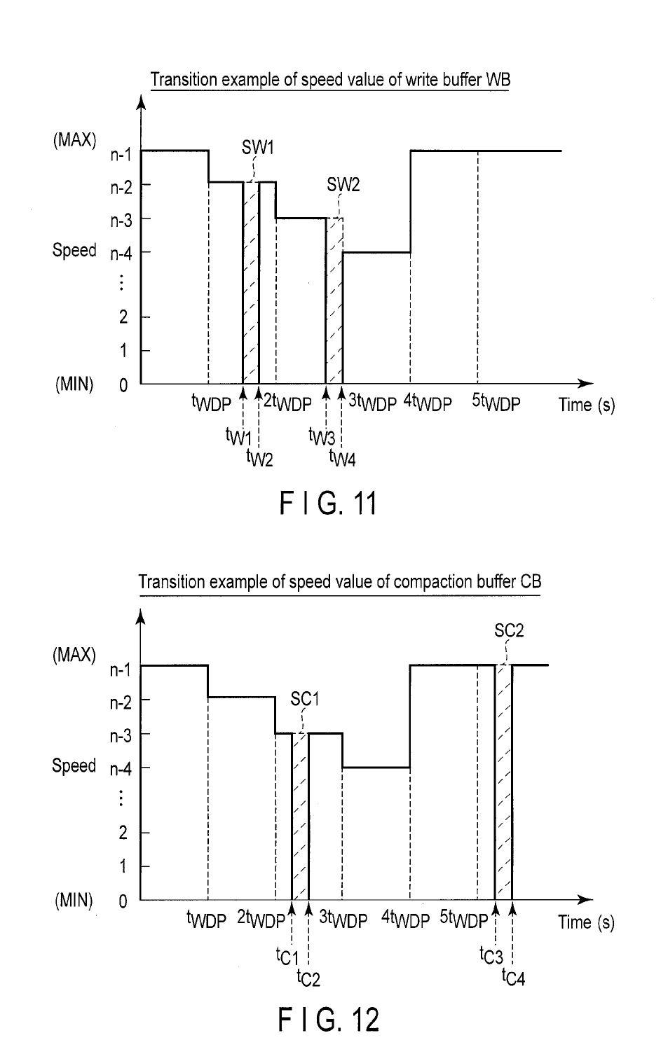

As a result of the above-mentioned control, the speed values of the write buffer WB and the compaction buffer CB are as shown in FIGS. 11 and 12, respectively. Note that the speed value of the write data path WDP complies with the speed value shown in the above-mentioned FIG. 8.

In the case of the write buffer WB, a stop signal is selected between times t_{W1} to t _{W2} and times t_{W3} to t _{W4} as shown in FIG. 11. During this period, the write buffer WB therefore stops and the speed value is 0 at the minimum. During the other periods, the write data path WDP operates at an updated speed of the write data path WDP.

In the case of the compaction buffer CB, a stop signal is selected between times t_{C1} to t_{C2} and times t_{C3} to t_{C4} as shown in FIG. 12. During this period, the compaction buffer CB therefore stops and the speed value is 0 at the minimum. During the other periods, the compaction buffer CB similarly operates at an updated speed of the write data path WDP.

[Effect]

As described above, at least the above-mentioned effects (1) to (3) can be obtained by the structure and the operation of the third embodiment. Further, the following effect (4) can be obtained according to the third embodiment.

(4) It is possible to reduce consumption power during a data compaction operation.

The condition determination unit 18C-1 of the third embodiment stops either of the write buffer WB or the compaction buffer CB, in which the processing to be performed does not exist or cannot be performed, at a predetermined ratio (1:0 or 0:1) (S36 or S39).

As shown in FIGS. 11 and 12, it is therefore possible to reduce dynamic consumption power corresponding to areas (SW1, SW2, SC1 and SC2), which are encircled by a broken line, during a data compaction operation. That is, when a predetermined compaction operates, the states of the write buffer WB and the compaction buffer CB are detected to stop either of the write buffer WB or the compaction buffer CB, in which the processing to be performed does not exist or cannot be performed. As a result, it is possible to further reduce consumption power effectively by stopping the extra operations of the write buffer WB and the compaction buffer CB, for example, without substantially reducing the processing speed as a whole of the solid-state drive 10.

Note that an example of a memory system from another perspective will be explained in the following. For example, at a predetermined compaction ratio (1:0 or 0:1), this memory system detects the states of the write buffer WB and the compaction buffer CB to stop either of the write buffer WB or the compaction buffer CB, in which the processing to be performed does not exist or cannot be performed. It is thereby possible to reduce consumption power of the memory system. Note that an operation of reducing the speeds of the read data path RDP and the write data path WDP, which are not the processing of a bottleneck, as in the above-mentioned first or second embodiments may not be necessarily performed in this memory system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a memory; and
a memory controller that controls the memory, the memory controller comprising:
a buffer capable of controlling a data transfer speed;
an interface unit that transmits data transferred by the buffer to an outside of the memory controller; and
a speed control unit that reduces the transfer speed of the buffer by reducing at least a power voltage of the buffer based on information at least either from the buffer or the interface unit, when the data transfer speed of the buffer is higher than a data transmission speed of the interface unit.

2. The memory system of claim 1, wherein
the interface unit is a host interface;
the buffer is a read buffer; and
the speed control unit controls a transfer speed of the read buffer based on information from the host interface during a data read operation of the memory.

3. The memory system of claim 2, wherein
the host interface comprises a read data buffer that transmits read data transferred from the read buffer to the outside; and
the speed control unit, during the data read operation of the memory, reduces the transfer speed of the read buffer when a storage state of the read data buffer is a predetermined state and returns the data transfer speed of the read buffer when the storage state of the read data buffer deviates from the predetermined state.

4. The memory system of claim 3, wherein
the data transfer speed of the read buffer is set in a plurality of stages; and
the speed control unit, during the data read operation of the memory, reduces the data transfer speed of the read buffer from a maximum value at least by one stage when the storage state of the read data buffer is the predetermined state by referring to the storage state of the read data buffer at each predetermined time.

5. The memory system of claim 4, wherein
the speed control unit, during the data read operation of the memory, returns the data transfer speed of the read buffer to the maximum value when the storage state of the read data buffer deviates from the predetermined state.

6. The memory system of claim 4, wherein
the predetermined state is at least any one of:
a full state where data cannot be stored in the read data buffer any more;
a state where the data storage state of the read data buffer exceeds a predetermined percentage; and
a state expected to be the full state.

7. The memory system of claim 2, wherein
the speed control unit stops the read buffer when the host interface does not process a READ command.

8. The memory system of claim 1, wherein
the buffer is a write buffer; and
the speed control unit controls a transfer speed of the write buffer based on information from the write buffer during a data write operation of the memory.

9. The memory system of claim 8, wherein
the speed control unit, during the data write operation of the memory, reduces the transfer speed of the write buffer when a storage state of the write buffer is a predetermined state and returns the data transfer speed of the write buffer when the storage state of the write buffer deviates from the predetermined state.

10. The memory system of claim 8, wherein
the data transfer speed of the write buffer is set in a plurality of stages; and
the speed control unit, during the data write operation of the memory, reduces the data transfer speed of the write buffer from a maximum value at least by one stage when a storage state of the write buffer is a predetermined state by referring to the storage state of the write buffer at each predetermined time.

11. The memory system of claim 10, wherein
the speed control unit, during the data write operation of the memory, returns the data transfer speed of the write buffer to the maximum value when the storage state of the write buffer deviates from the predetermined state.

12. The memory system of claim 10, wherein
the predetermined state is at least any one of:
a full state where data cannot be stored in the write buffer any more;
a state where the data storage state of the write buffer exceeds a predetermined percentage; and
a state expected to be the full state.

13. The memory system of claim 8, wherein
the memory controller further comprises:
a compaction buffer capable of controlling a data transfer speed; and
a compaction control unit that controls a compaction ratio between the write buffer and the compaction buffer, wherein
the speed control unit controls a transfer speed of the compaction buffer based on information from the compaction buffer, during the data write operation of the memory.

14. The memory system of claim 13, wherein
the speed control unit, during the data write operation of the memory, stops the write buffer or the compaction buffer in accordance with control of the compaction control unit.

15. The memory system of claim 1, wherein
the memory is a NAND flash memory.

16. A memory system comprising:
a memory; and
a controller that controls the memory, the controller comprising:
a data transfer unit capable of controlling a data transfer speed;
an interface unit that transmits data transferred by the data transfer unit to an outside of the controller; and
a speed control unit that reduces the transfer speed of the data transfer unit based on information at least either from the data transfer unit or the interface unit.

17. The memory system of claim 16, wherein
the speed control unit reduces the transfer speed of the data transfer unit based on a signal from the interface unit.

18. The memory system of claim 16, wherein
the speed control unit reduces the transfer speed of the data transfer unit based on a signal from the data transfer unit.

19. The memory system of claim 16, wherein
the data transfer speed of the data transfer unit is changeable at least to a first transfer speed and a second transfer speed, which is lower than the first transfer speed, in addition to a stopped state.

20. A memory system comprising:
a memory; and
a controller comprising a data transfer unit and a speed control unit, which controls a transfer speed of the data transfer unit based on a state of a data transfer destination during an operation of the memory.
